(19) United States
(12) Patent Application Publication
(10) Pub. No.: US 2009/0039945 A1
(43) Pub. Date: Feb. 12, 2009

(54) Bias Current Generator

(76) Inventors: Matthias Arnold, Freising (DE); Johannes Gerber, Unterschleissheim (DE)

Correspondence Address: TEXAS INSTRUMENTS INCORPORATED, P O BOX 655474, M/S 3999, DALLAS, TX, 75265, US

(21) Appl. No.: 12/147,048

(22) Filed: Jun. 26, 2008

Related U.S. Application Data
(60) Provisional application No. 61/016,732, filed on Dec. 26, 2007.

(30) Foreign Application Priority Data
Jul. 9, 2007 (DE) 10 2007 031 902.0

(51) Int. Cl. G05F 3/16

(52) U.S. Cl. 327/513

(57) ABSTRACT

An electronic device generates a current with a predetermined temperature coefficient. The circuit comprises a temperature coefficient (TC) component receiving a bias current, a differential amplifier providing a buffered output voltage based on the voltage across the TC component and a resistor receiving an TC current based on the differential amplifier output voltage. The differential amplifier has a predetermined input related offset which decreases the voltage drop across the resistor. The temperature coefficient component could have either a negative temperature component (NTC) or a positive temperature component (PTC).

### CLAIM OF PRIORITY

This application claims priority under 35 U.S.C. 119(a) to German Patent Application No. 10 2007 031 902.0 filed Jul. 9, 2007 and 35 U.S.C. 119(e)(1) to U.S. Provisional Application No. 61/016,732 filed Dec. 26, 2007.

### TECHNICAL FIELD OF THE INVENTION

The technical field of this invention is an electronic device comprising circuitry for generating a bias current with a defined temperature coefficient (TC) and a corresponding method.

### BACKGROUND OF THE INVENTION

Integrated electronic circuits need all kinds of bias current or voltage generating stages. In order to provide specific temperature dependent effects and to compensate for temperature dependent behavior of the circuitry, bias current or bias voltage generators with positive or negative temperature coefficients (PTC, NTC) are used. The resistance of a device with an NTC decreases with rising temperature. Typically, these NTC-based current generators are combined with components having a positive temperature coefficient (PTC) having together reduced or no temperature dependency. One prior art solution for generating an NTC current uses a feedback loop to force a base-emitter voltage (V_{BE}) of a bipolar transistor or a forward voltage of a diode across a resistor. This causes the current through the resistor to have the NTC of the bipolar transistor's base emitter voltage V_{BE}. If the feedback circuitry should have very low power consumption, the resistance of the resistor should be very large or the V_{BE} has to be very small. However, the range and the flexibility of V_{BE} is very restricted and it typically amounts to 700 to 800 mV resulting in a resistance of several MΩ for a target current of several hundred nA. A resistor having such a high resistance requires a lot of chip area if implemented as a typical sheet resistor.

### SUMMARY OF THE INVENTION

It is an object of the present invention to provide an electronic device including circuitry for generating a current with a specific temperature coefficient requiring less chip area and less power consumption than the prior art.

According to an aspect of the present invention, an electronic device includes circuitry for generating a current with a predetermined temperature coefficient (TC). For example, the circuitry includes an NTC component coupled to receive a bias current, a differential amplifier connected so as to buffer a voltage across the NTC component for providing a buffered output voltage based on the voltage across the NTC component, a resistor connected so as to receive an NTC current based on the differential amplifier output voltage, wherein the differential amplifier has a predetermined input related offset, so as to decrease the voltage drop across the resistor. Accordingly, in this aspect of the present invention the differential amplifier used to buffer the voltage having a negative temperature coefficient has an offset, such that the output voltage is systematically reduced allowing a smaller resistor value to be used for the resistor coupled to the output of the differential amplifier. This principle is also applicable to a PTC component.

An input related offset can be implemented in many different ways in the differential amplifier. For example, the differential input pair of a differential amplifier implemented in a CMOS technology can be dimensioned such that one of the transistors of the differential pair has a substantially larger width or a larger width to length ratio than the other transistor. Using a ratio of an integer factor N of the width of the transistors makes implementation as an integrated circuit easier and more reliable. The NTC component can be a bipolar transistor or a forward biased diode. Advantageously, the differential amplifier can be a folded cascode transconductance amplifier. However, if the input stage of such a differential amplifier is modified to provide an input related offset in the output, the voltage drop of a resistor coupled to the output of the amplifier can be reduced. The resistor can have a smaller resistance and the area required to implement the resistor can thus be reduced. Preferably, the offset can lie between 300 mV and 500 mV. Although the present invention is described mainly with respect to an NTC component, it also possible to implement the circuitry with a PTC component.

According to an aspect of the present invention, a method generates a current with a predetermined temperature coefficient. The method preferably includes the steps of providing a voltage across an NTC component, buffering the voltage across the NTC component using a buffering device having an input related offset so as to reduce an output voltage of the buffering device and applying the reduced output voltage across a resistor.

### BRIEF DESCRIPTION OF THE DRAWINGS

These and other aspects of this invention are illustrated in the drawings, in which:

FIG. 1 illustrates a simplified circuit diagram of an NTC current generator according to the prior art;

FIG. 2 illustrates a simplified circuit diagram of a first embodiment of the present invention;

FIG. 3 illustrates a simplified circuit diagram of an amplifier according to an aspect of the present invention; and

FIG. 4 illustrates a simplified circuit diagram of a second preferred embodiment of the present invention.

### DETAILED DESCRIPTION OF PREFERRED EMBODIMENTS

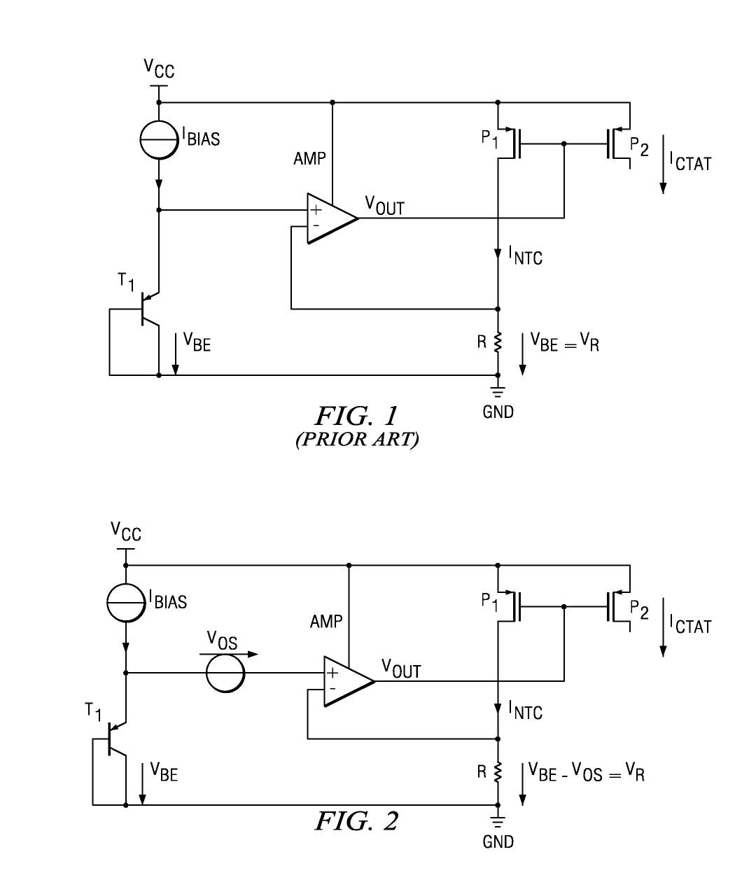

FIG. 1 shows a simplified block diagram of an NTC current generator according to the prior art. Bipolar transistor T1 has a base to emitter voltage V_{BE}. The transistor receives a bias current I_{bias} from a constant current source. The base to emitter voltage V_{BE} is coupled to the positive input of a differential amplifier AMP. The output of the amplifier AMP is coupled to the gates of PMOS transistors P₁ and P₂. The source of PMOS transistor P₁ is coupled to a supply voltage V_{CC} and its drain is coupled to the negative input of the amplifier AMP and a resistor R. Due to the feedback connection of the amplifier AMP, the base to emitter voltage V_{BE} of bipolar transistor T1 also appears across resistor R. The output current I_{CTAT} at PMOS transistor P₂ is used for further biasing purposes having the desired temperature coefficient (TC). The TC of the output current I_{CTAT} can be negative. However, the NTC can also be partially compensated or completely compensated by a PTC of the resistor R. The area of the resistance can be reduced by reducing the voltage across the resistor R. However, since V_{BE} is technology dependent and not easily reduced, there is a need for a different solution as provided by the present invention.

FIG. 2 shows a simplified circuit diagram of an embodiment of the present invention. The circuit includes mostly the same components as the prior art circuit shown in FIG. 1. This invention includes voltage source V_{OS} at the positive input of the differential amplifier AMP. As with the circuit shown in FIG. 1, bipolar transistor T1 is biased by the bias current source I_{bias}. Accordingly, the sum of the base to emitter voltage V_{BE} and the offset voltage V_{OS} appears at the positive input node of the differential amplifier. As a consequence of the feedback connection at the output of the amplifier AMP, the voltage drop across the resistor R is reduced by the offset voltage V_{OS} at the positive input of the amplifier AMP. Due to this offset and the reduced voltage drop across the resistor R, the resistance of resistor R can be reduced. This reduction in resistance permits a reduction in the required chip area for the resistor R. However, the temperature behavior of the output current I_{CTAT} is the same as for the prior art circuit of FIG. 1.

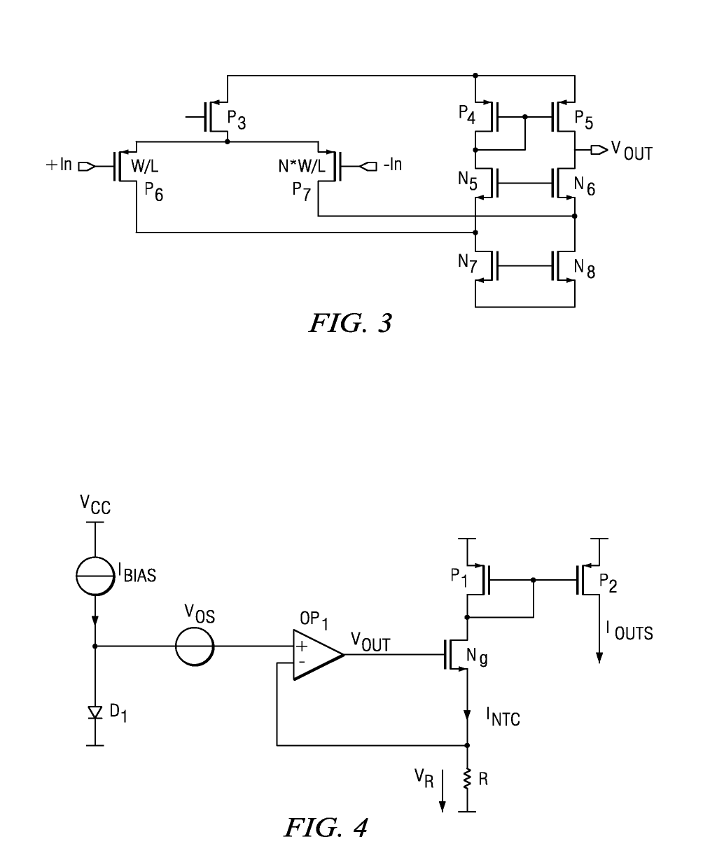

FIG. 3 shows a simplified circuit diagram of a differential amplifier according to an aspect of the present invention. FIG. 3 illustrates a folded cascode transconductance amplifier including a differential input stage having two PMOS transistors P6 and P7. The input transistors P6 and P7 have different dimensions, the width of the PMOS transistor P7 is N times the width of the PMOS transistor P6. This introduces an offset into the operational amplifier, as indicated in the FIG. 2 by independent voltage source V_{OS}. This folded cascode operational amplifier can preferably be used as the differential amplifier AMP of FIG. 2. The remaining transistors P4, P5, N5, N6, N7 and N8, as well as P3, are dimensioned as usual for this type of operational amplifier. A particular advantage of the folded cascode configuration is a small output offset and inherent stability, which make the folded cascode operational amplifiers particularly useful for integrated circuit design. Dimensioning the input stages as indicated in FIG. 3 with a preferably integral factor of N is easy to implement and allows a precisely predetermined desired offset.

Table 1 shows the exemplary area savings using the circuit of FIG. 3 in an arbitrary CMOS technology.

TABLE 1

| | Area in μm² | | | |
|---|---|---|---|---|
| | Operational | Operational | | |
| | Amplifier | Amplifier | | |
| Total I_{DD} | without | with 370 mV | Absolute | Relative |
| in nA | offset | offset | Saving | Saving |
| 20 | 131000 | 107000 | 24000 | 18% |
| 30 | 30000 | 25000 | 5000 | 17% |
| 40 | 17000 | 15000 | 2000 | 12% |
| 100 | 5500 | 4800 | 700 | 13% |

For this example, the base emitter voltage V_{BE} is 450 mV and the offset voltage V_{OS} is 370 mV. The total supply current I_{DD} includes 10 nA output current (I_{CTAT}) and 7 nA amplifier current. The area includes the area for the bipolar transistor which is 1,000 μm². Accordingly, the resistor area can be reduced by up to about 20%. There are many different ways to introduce an offset into a differential amplifier. FIG. 3 illustrates one possibility where the input transistors have different dimensions. However, the output transistors in the two branches can also have different dimensions.

FIG. 4 illustrates a simplified circuit diagram of another preferred embodiment of the present invention. A forward biased diode D1 is used to provide a voltage level with a negative temperature coefficient. As in FIG. 2, the operational amplifier OP1 has an additional offset voltage source V_{OS} coupled to its positive input. However, the feedback connection at the output of OP1 is different. The output of operational amplifier OP1 is directly coupled to the gate of NMOS transistor N9. The voltage between the source of N9 and resistor R is coupled to the negative input of the differential amplifier OP1. The PMOS transistors P1 and P2 are coupled in a current mirror configuration to provide an output current I_{OUTS}. The circuit of FIG. 4 provides the same advantages as set out with respect to FIG. 3.

Although the present invention was mainly described with respect to a NTC component, the NTC component can generally be replaced by a PTC component, which has a constant voltage drop.

What is claimed is:

1. An electronic device comprising circuitry for generating a current with a predetermined temperature coefficient (TC) comprising:
a bias current source (I_{bias});
an TC component (T1) receiving the bias current (I_{bias});
a resistor (R);
a current source (P1, P2) supplying current (I_{NTC}) to the resistor (R); and
a differential amplifier (AMP) having a positive input receiving a voltage across the TC component (T1), a negative input receiving a voltage across the resistor (R) and an output controlling the current source (P1, P2), the differential amplifier (AMP) having a predetermined input related offset (V_{OS}) on the positive input to decrease the voltage drop (V_{R}) across the resistor (R).

2. The electronic device according to claim 1, wherein:
the differential amplifier (AMP) has a differential input stage including
a first input MOSFET transistor connected to the positive input having a first width/length ratio, and
a second input MOSFET transistor connected to the negative input having a second width/length ratio different from the first width/length ratio selected to provide the input related offset (V_{OS}).

3. The electronic device according to claim 2, wherein:
the second width/length ratio is an integral N times the first width/length ratio.

4. The electronic device according to claim 1, wherein:
the TC component is a bipolar transistor (T1).

5. The electronic device according to claim 1, wherein:
the TC component is a forward bias diode (D1).

6. The electronic device according to claim 1, wherein:
the differential amplifier (AMP) is a folded cascode transconductance amplifier.

7. The electronic device according to claim 1, wherein:
the offset voltage (V_{OS}) is between 300 mV and 500 mV.

8. A method for generating a current (I_{NTC}) with a predetermined temperature coefficient (TC), comprising:
providing a voltage (V_{BE}) across a component having a predetermined temperature coefficient (TC);
buffering the voltage (V_{BE}) across the TC component by use of a buffering device (AMP) having an input related offset (V_{OS}) so as to reduce an output voltage (V_{OUT}) of the buffering device (AMP); and
applying the reduced output voltage across a resistor (R).
